(19) United States
(12) Patent Application Publication
(10) Pub. No.: US 2022/0185481 A1
(43) Pub. Date: Jun. 16, 2022

(54) Sleeping Assist Device for Airplane Passengers

(71) Applicant: Thanomsak Hongthong, Port Charlotte, FL (US)

(72) Inventor: Thanomsak Hongthong, Port Charlotte, FL (US)

(21) Appl. No.: 17/120,316

(22) Filed: Dec. 14, 2020

(51) Int. Cl. B64D 11/06

(52) U.S. Cl. CPC B64D 11/0602

(57) ABSTRACT

A sleeping assist device for providing help for both obese and non-obese passengers to sleep while traveling on an airplane consists of a primary model for non-obese passengers and a second model for obese passengers. The primary device includes an adjustable length support tube that rests on the lap of the passenger during use. A face sleeping cushion is adjusted in height using a pair of tubes with a tube locking mechanism that can be locked to set the height. A pair of locking mechanisms are attached to a cushion support plate and allow the tilt angle of the face cushion to be adjusted. An adjustable length belt attached to the cushion support plate is used to hold the device securely using two airplane seat mounting brackets. A security ring is welded to the lower tube to prevent the device being used as a weapon by use of a steel wire cable that attaches to the security ring and to a second ring mounted to the passenger seat mounting frame.

The secondary device for obese passengers also includes an adjustable length support tube that rests on the lap of the passenger during use. A face sleeping cushion is adjusted in height using a locking mechanism that can be locks the position between the lower tube and a first bar. The first bar and a second bar connected to the cushion support plate are fixed in both angular and translational position by using a thumb screw to adjust cushion tilt and a locking mechanism to adjust the translation of the second bar. An adjustable length belt attached to the cushion support plate is used to hold the device securely using two airplane seat mounting brackets. A security ring is welded to the lower tube to prevent the device being used as a weapon by use of a steel wire cable that attaches to the security ring and to a second ring mounted to the passenger seat mounting frame.

### CROSS REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION BY REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR A JOINT INVENTOR

Not Applicable

### FIELD OF THE INVENTION

His invention relates generally to the field of sleeping assist devices, and in particular to a sleeping assist device to help passengers sleep while traveling in an airplane.

### BACKGROUND OF THE INVENTION

There have been some sleeping aid devices from prior art, but all of these have inherent problems which the present invention aims to solve. For example, U.S. Pat. No. 10,449,882 issued to Lev discloses a passenger sleeping aid device that includes an adjustable length arm that can either rest on the seat flip down tray or can attach to the top of the seat of the next passenger seat in front. U.S. Pat. No. 6,692,069 issued to Beroth et al discloses an aircraft sleeper seat that has a retractable mechanism that can unfold and allow the passenger to sleep flat and push their feet underneath the seat in front. U.S. Pat. No. 6,000,659 issued to Brauer discloses a fully reclinable pivotable airplane passenger seat that allows unused aisle space to be used to allow a passenger to sleep completely in a horizontal position.

The travel sleeping aid of Lev presents two inherent problems. First, when the device is used in the short arm mode resting on the tray table, turbulence from the plane will shake the legs and likely waken the passenger from sleep. Second, when the device is used in the long arm mode the legs themselves end over the top of the seat of the next forward passenger which surely will cause irritation if the other passenger's head rubs against a hard object.

The aircraft sleeper seat of Beroth also presents two inherent problems. First, the design appears to be mechanically cumbersome to remove and assumes the passenger has good mechanical skills which is often not the case. Beroth's device would require flight attendants to spend time around the plane setting up the device for sleeping. The other major flaw is that the device does not consider that many passengers store items underneath their seats and therefore would have no room for using the device which requires sufficient space for the feet to rest in.

The fully reclinable and pivotable airplane passenger sleeper seat of Brauer has several inherent problems. First, such as seat would not be well received by almost every airline in existence because it would cause the airline owners to lose substantial profits because employing such seats would substantially reduce the number of passengers onboard due to the extra space required to fully recline the seat for sleeping. Secondly, the patent discusses taking up aisle space which would present a huge safety problem during an aircraft emergency. Clearly, the need exists for a simple sleeping device that the average person can easily setup without help from flight attendants and would not interfere or cause irritation with adjacent passengers.

### BRIEF SUMMARY OF THE INVENTION

It is a primary object of the present invention to provide a sleeping assist device that is easily adjustable for both obese and non-obese passengers.

It is a second object of the present invention to provide a sleeping assist device that is portable and compact and can be stowed underneath the seat when not in use.

It is a final object of the present invention to provide a sleeping assist device that provides security against being used as a weapon by a hostile passenger.

### BRIEF DESCRIPTION OF THE DRAWINGS

FIG. 1 is a front perspective view of a primary embodiment of the sleeping assist device.

FIG. 2 is a rear perspective view of the primary embodiment of the sleeping assist device.

FIG. 2(a) is a detailed view of the cushion tilt adjustment mechanism taken along circle A of FIG. 2.

FIG. 3 is a detailed view of the top tube height adjustment mechanism.

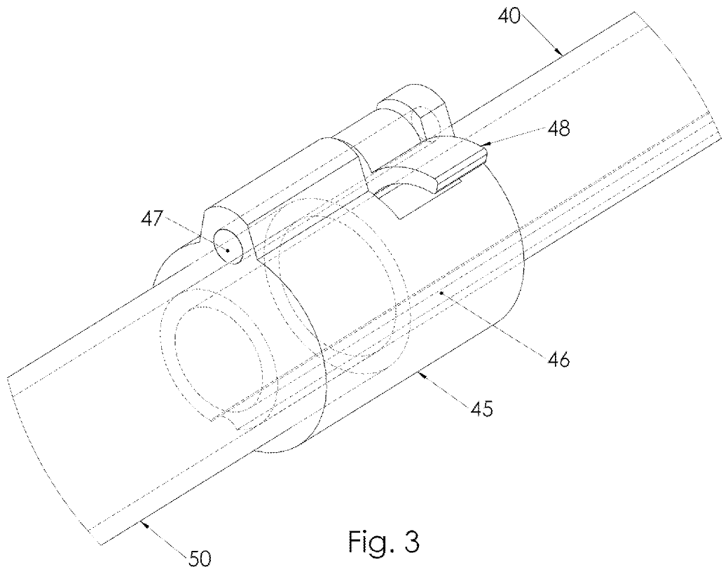

FIG. 4 is a side view showing a non-obese passenger sleeping using the primary embodiment of the sleeping assist device.

FIG. 5 is a rear perspective view of the primary embodiment of the sleeping assist device showing how the belt is secured to the passenger seat.

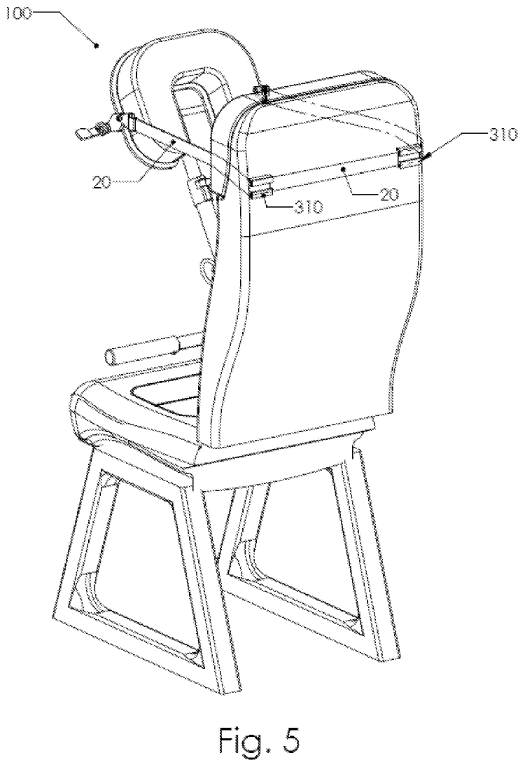

FIG. 6 is a left side rear perspective view of the secondary embodiment of the sleeping assist device.

FIG. 7 is a right-side rear perspective view of the secondary embodiment of the sleeping assist device.

FIG. 7(a) is a detailed view of the tilt adjustment mechanism taken along circle B of FIG. 7.

FIG. 7(b) is a detailed view of the translational adjustment mechanism taken along circle B of FIG. 7.

FIG. 8 is a side view showing an obese passenger sleeping using the secondary embodiment of the sleeping assist device.

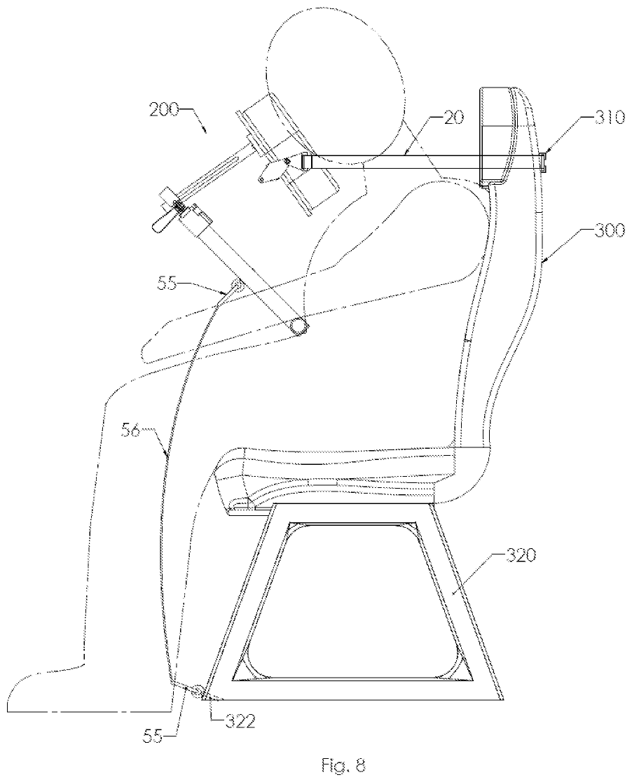

### DETAILED DESCRIPTION OF THE INVENTION

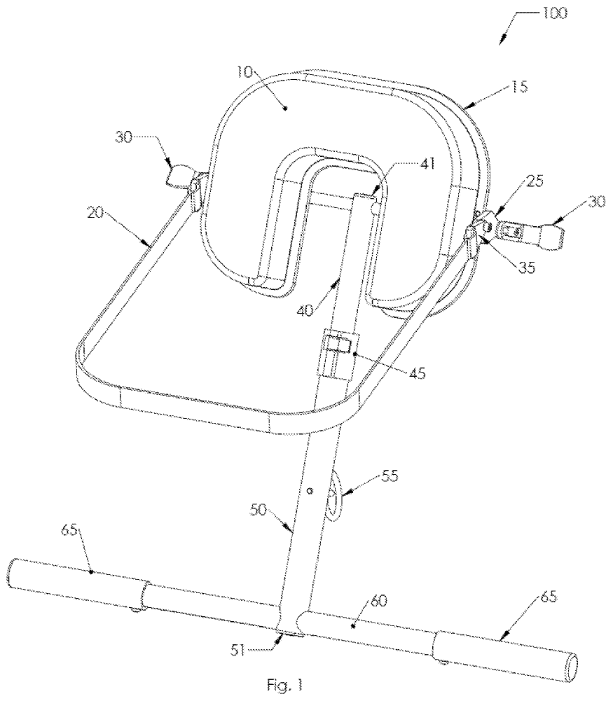

Referring now to the drawings and in particular FIGS. 1 & 2, the primary embodiment of the sleeping assist device according to the present invention is generally designated by reference numeral 100. Sleeping assist device 100 includes a pair of hollow open ended aluminum tubes 40 and 50 which slidably engage with each other. A locking mechanism 45 is used to set the height of the device based on the passenger's height. The passenger first rests the transverse tube 60 against the top of their legs and then adjusts the height of top tube 40 until their face rests comfortably against the face cushion 10. Cushion 10 is removably attached to cushion support plate 15 using typical fastener methods such as Velcro strips. A first end cap 51 is rigidly attached to the bottom distal opening of lower tube 50 and has a centered threaded thru hole for use with a locking set screw 52 to rigidly fix the position of the transverse tube 60 to bottom tube 50 as shown in FIG. 1. A second end cap 41 is rigidly attached to the upper distal opening of upper tube 40 and has a centered threaded thru hole for use with a second locking set screw 52 (not shown) to rigidly fix the position of transverse tube 70 to upper tube 40 as shown in FIG. 1.

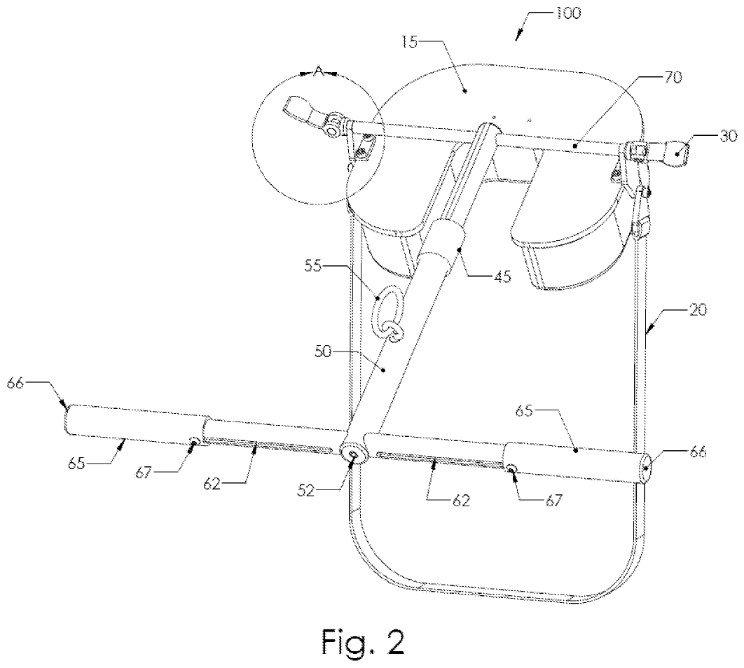

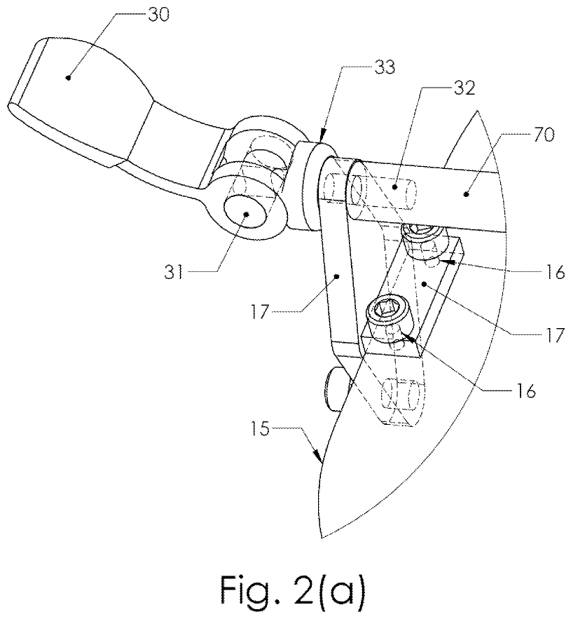

Referring again to FIGS. 1 & 2, the transverse tube 60 may be lengthened if needed for passengers with wider hips by using two extension tubes 65, one at each end of the transverse tube 60. Each extension tube 65 mates with an end cap 66 which is press fit into the distal opening as shown. The extension tubes are slidably engaged to the transverse tube by sliding along a slot 62 located on transverse tube 60. Two screws 67 are fastened to two tapped holes (not shown) on transverse tube 60 in order to prevent the extension tubes 65 from falling off the transverse tube. Lower tube 50 also contains a hole used to weld a securing ring 55 approximately as shown in FIG. 2. The purpose of the securing ring is to prevent a hostile passenger from using the sleeping assist device as a weapon against other people onboard the plane. The ring 55 must be welded to the tube 50 so that the ring cannot be detached from the sleeping assist device.

Referring next to FIG. 2(a), a detailed view of the tilt adjustment mechanism is shown. The tilt adjustment mechanism allows the passenger to adjust the proper tilt angle of the face cushion 10 when it is being used for sleeping. The mechanism consists of a mounting bracket 17 which is preferably diamond shaped and has a protrusion along its horizontal centerline. The bracket 17 is rigidly attached to the cushion support plate 15 using two screws 16. A top thru hole is located on bracket 17 and is used for a threaded rod 32 to be rigidly attached to each end of tilt tube 70. The distal end of threaded rod 32 has cuts to allow either a typical Phillips head or standard flat screwdriver to be used to attach the threaded rod into the tilt tube. A pin 31 is rigidly attached to rod 32 by a thru hole located at the center of pin 31. Pin 31 is concentrically attached to locking handle 30 and allows free rotation of the handle which is mated to a cam locking washer 33. Washer 33 is mated against the bracket 17 and creates a frictional locking fit once the handle is rotated such that the washer is slightly compressed.

Referring next to FIGS. 2 & 3, the tube locking mechanism is next shown. Once the passenger extends the top tube 40 to the proper height, then the locking thumb tab 48 is pressed into the main housing 45. Housing 45 contains a protrusion (not shown) at one distal end. The protrusion fits into a groove 46 (shown in both FIGS. 2 & 3) on upper tube 40 and prevents the upper tube from falling out of the lower tube. The protrusion in housing 45 also prevents a hostile passenger from detaching the cushion from the lower tube and using that as a weapon. A pin 47 is used to secure the thumb tab 48 into housing 45.

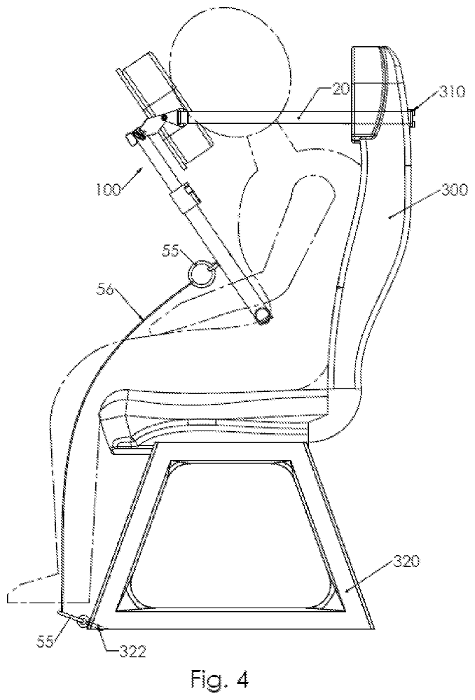

Referring now to FIGS. 1, 4 & 5, the use of the sleeping assist device 100 is shown with a non-obese passenger sitting in airplane seat 300. A seat securing frame 320 is rigidly attached to seat 300 and is modified by attaching a second securing ring 55 at the forward face of the frame using a hole. The second securing ring 55 is also welded to the aluminum frame 320 so that hostile passengers cannot use the sleeping device as a weapon. A steel wire cable 56 is rigidly attached to both securing rings 55 as shown. Thus, the device 100 can never be removed from the seat and used to harm other passengers. A belt 20 is secured to the sleeping device 100 by attaching to belt bracket 35 at both sides of the device as shown. The belt also passes behind the seat 300 and is secured to the seat using seat belt mounting brackets 310. Unlike other prior art sleeping devices, the present invention solves the problem of not interfering with the comfort of other adjacent passengers. Once the tilt of the cushion 10 has been adjusted using the tilt adjustment mechanisms, the passenger simply rests their face against the cushion and can sleep comfortably with the belt securing method.

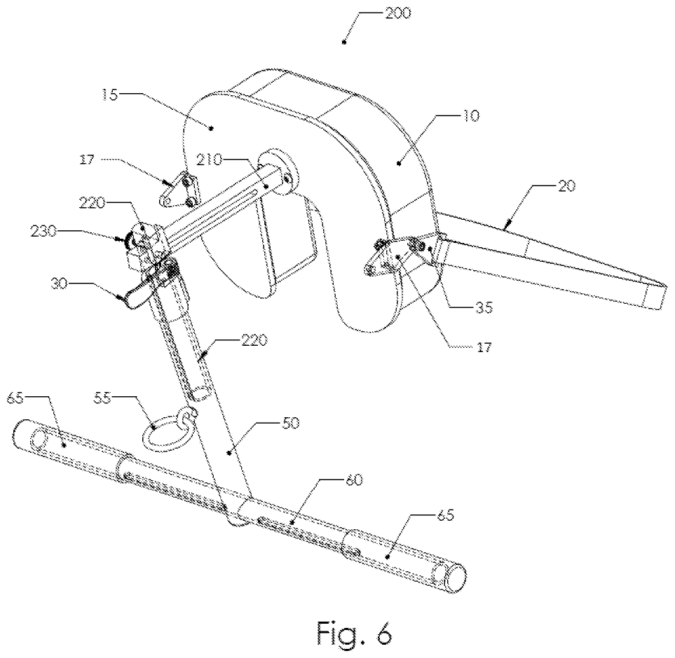

Referring next to FIGS. 6 & 7, the secondary embodiment of the sleeping assist device is shown by device 200. The lower portion of device 200 is identical to device 100. Specifically, the lower tube 50, the height adjustment mechanism, the securing ring 55, the transverse tube 60 and extension tubes 65 as well as all associated fasteners used in the primary embodiment are the same in form and function. The top tube 40 from device 100 is replaced with a top tube 220. The tilt adjustment mechanism of device 100 is replaced by a new tilt and translational mechanism which shall next be explained. The cushion 10, cushion support plate 15, securing belt 20, belt mounting bracket 35 are also components in device 200 and share the same form and function as in the primary embodiment. The sole exception is bracket 17 which is no longer used as part of the cushion tilt adjustment. In the secondary embodiment, the bracket 17 is only used as an attachment point to the belt bracket 35 as shown.

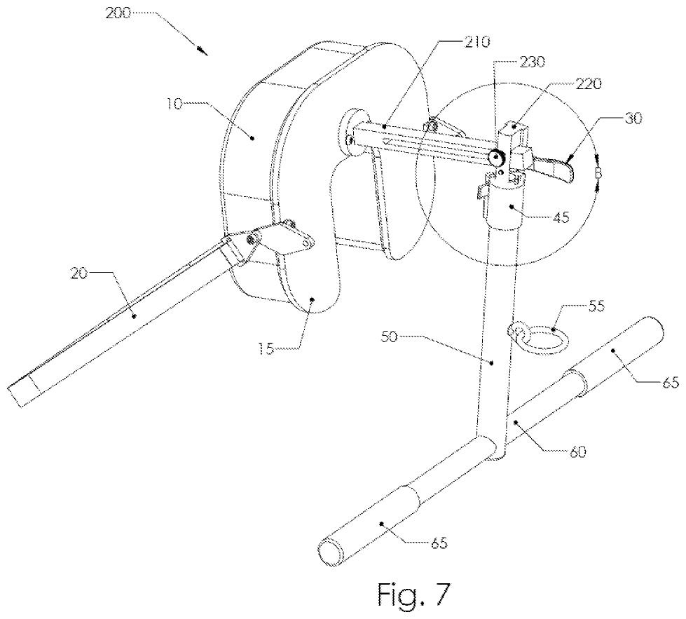

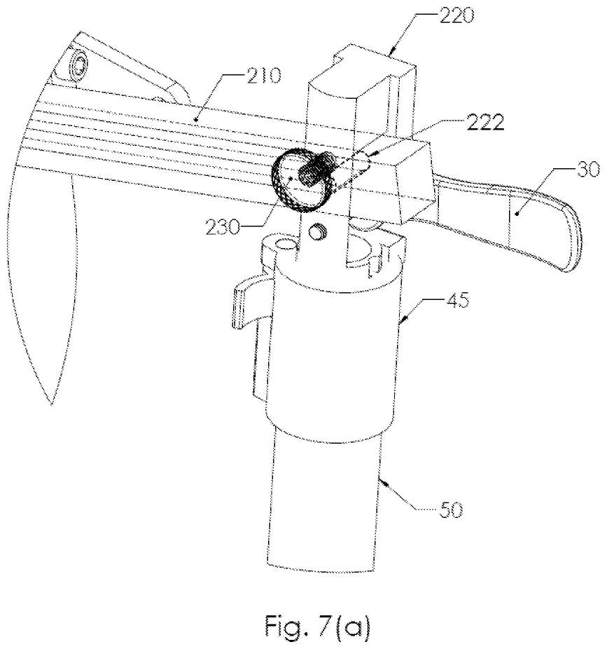

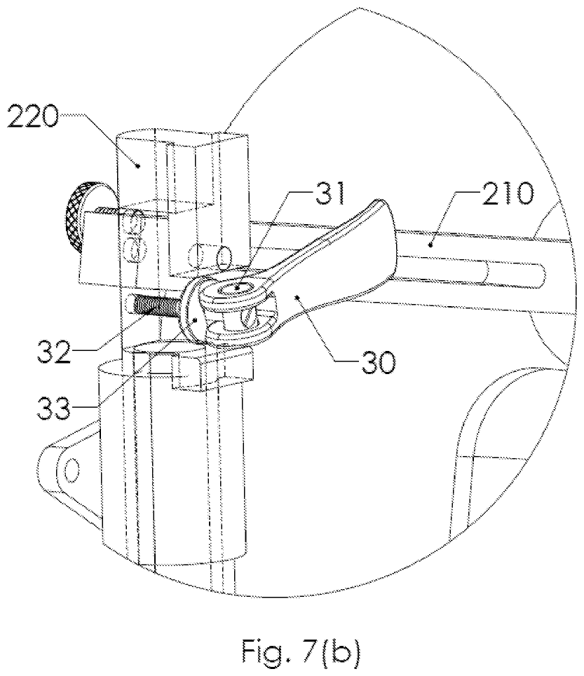

Referring next to FIGS. 7 & 7(a), the tilt mechanism shall next be explained. Obese passengers are expected to have a difficult time sleeping using the primary device 100 due to their body shape, so the secondary embodiment (device 200) is the preferred device for obese passengers to use for sleeping. The tilting angle is adjusted by rotating 210 about pin 222 which is rigidly mounted to upper tube 220. Once the proper angle is found, the passenger turns thumb screw 230 which drives tube 210 against the adjacent flat surface on upper tube 220. This action creates a frictional lock between the tubes 210 and 220 once the screw is tightened sufficiently.

Referring next to FIGS. 7 & 7(b), the translational mechanism shall next be explained. When adjusting the position of the head cushion 10 away from the chest of the passenger, tube 210 is extended away from the passenger's chest until the cushion 10 rests comfortably on the passenger's face. Once the proper position of tube 210 is set, the handle 30 is pushed towards tube 220. This action causes the cam locking washer to press against the adjacent flat surface of tube 210 and creates a frictional lock between tubes 210 and 220. If the position needs further adjustment, then handle 30 is pulled away from tube 220 which removes the pressure of the locking cam washer 33 against tube 210 and allows tube 210 to freely slide again along pin 222.

Referring finally to FIGS. 7 & 8, the use of the sleeping assist device 200 is shown with an obese passenger sitting in airplane seat 300. A seat securing frame 320 is rigidly attached to seat 300 and is modified by attaching a second securing ring 55 at the forward face of the frame using a hole. The second securing ring 55 is also welded to the aluminum frame 320 so that hostile passengers cannot use the sleeping device as a weapon. A steel wire cable 56 is rigidly attached to both securing rings 55 as shown. Thus, device 200 can never be removed from the seat and used to harm other passengers. A belt 20 is secured to the sleeping device 200 by attaching to belt bracket 35 at both sides of the device as shown. Once the position of tube 210 has been set and locked in by the thumb screw 230 and handle 30, the passenger simply rests their face against the cushion and the device is held in place by belt 20 which is strapped to seat 300 using two belt brackets 310 one on each side of the passenger's seat.

What is claimed is:

1. A first apparatus for assisting non-obese airplane passengers to sleep during air travel, comprising:
a first hollow tube; said tube having two slotted apertures located symmetrically about its center point; said first tube to provide means for resting on said passenger's lap during sleeping;
a pair of second hollow tubes; said second tubes having a closed face at one distal end and a hollow opening at the opposite distal end to provide means of slidable engagement with said first tube; said second tubes having a blind threaded hole near the open distal end to provide means for attachment of a screw to provide a means to limit the travel of said second tubes in slidable engagement with said first tube;
a third hollow tube; said third tube having a blind hole to provide a means of rigid attachment to a metal security ring; said third tube having a transverse thru hole near its bottom distal end to provide a means for attachment of said first tube;
a first end cap, said first end cap having a threaded thru hole at its center to provide a means for locking the position of said first tube using a set screw;
a pair of second end caps, said second end cap having a closed outside face and a smaller diameter end to provide a means for rigid attachment to the far distal end of said second hollow tubes;
a fourth hollow tube; said fourth tube having a smaller outside diameter to provide slidable engagement with said third tube; said fourth tube having a transverse thru hole near its upper distal end to provide means for attachment to a rod; said fourth tube having a notch shaped cut running along entire length of said fourth tube to prevent rotation between said fourth tube and said third tube;
a rod; said rod attached to said fourth tube by mating with said transverse thru hole of said fourth tube; said rod having blind tapped holes at the center of both distal ends;
a third end cap; said third end cap having a threaded thru hole at its center to provide a means for locking the position of said rod to said fourth hollow tube;
a tube locking device; said locking device comprising:
a hollow shaped housing with an internal diameter sized to press fit into said upper distal opening of said third tube; said housing having a thru hole running longitudinally to provide means for attachment to a pin; said housing having a notch shaped protrusion near its upper distal opening to provide a means for slidable engagement with said notch cut of said fourth tube;
a pin; said pin rigidly attached to said thru hole in said housing;
a thumb locking tab; said tab concentrically and movably attached to said pin;
said tab having a curved shape that provides a means for creating a frictional lock between said third and said fourth tubes;
a cushion; said cushion being U-shaped to provide a means for the passenger's head to press against said cushion where the nose and mouth of said passenger are inside the U opening to allow for breathing; said cushion having a plurality of Velcro strips attached to bottom face of said cushion to provide a means of attachment to a cushion support plate;
a cushion support plate; said plate being U-shaped; said plate having a plurality of Velcro strips to mate with said Velcro strips attached to said cushion provide means for detachment of said cushion to said plate; said plate having a plurality of tapped holes adjacent to its outer perimeter along the horizontal centerline to provide attachment means to a pair of rod mounting brackets;
a pair of rod mounting brackets; said brackets having a diamond shape with a single rectangular protrusion located at one side to provide a means of rigid attachment to said tapped holes of said cushion support plate; said brackets having two thru holes located near the apex of both triangular shaped end of said bracket to provide means of attachment; said first thru hole to provide a means for attachment of said rod mounting bracket to said threaded blind holes of said rod; said second thru hole to provide a means for attachment to a belt mounting bracket;
a belt mounting bracket; said mounting bracket being of triangular shape and having a blind hole at one corner of said bracket to provide a means for attachment to said rod mounting bracket; said belt mounting bracket having a slotted aperture adjacent and parallel to the bottom edge of said mounting bracket;
a belt comprising:
a pair of first belt sections being made of a strong polymeric fiber such as nylon;
said first belt section having a length between six and nine inches; said belt first section having closed loops at both distal ends; said first closed loop to provide a means of attachment to said slotted apertures of said belt mounting bracket; said second closed loop to provide a means of attachment to a belt buckle;
a pair of first belt buckles; said buckles having a slotted aperture at one distal end to provide a means for attachment to said second closed loops of said first belt sections; said buckles having a rectangular aperture at the opposite distal end to provide a means for attachment to a pair of second belt buckles;
a pair of second belt buckles; said second buckles having a pair of slotted apertures at one distal end to provide a means for attachment to a pair of second belt sections; said second buckles having a pair of flexible locking tabs at the opposite distal end to provide a means of releasable attachment to said rectangular apertures of said first belt buckles; and a
a second belt section; said second belt section being made of a strong polymeric fiber such as nylon; said second belt section having a length between 55 and 60 inches; said second belt section having thicker ends to provide a means for preventing detachment from said second belt buckles; said second belt section being looped thru said pairs of slotted apertures of said second buckles to provide a means of length adjustment of said belt;
a pair of belt securing brackets; said belt securing brackets being rigidly attached to the backside of the passenger's seat at approximately 6 to 8 inches from the top face of said seat and adjacent to the seat perimeter; said brackets each having two L shaped protrusions along the top and bottom edges to provide a means for retaining said belt;
a pair of cushion tilt adjustment devices; said tilt adjustment devices each comprising:
a handle; said handle having a curved shape at one distal end and a cylindrical shape at the far distal end; said cylindrical shape having a thru hole at its center to provide a means for rigid attachment to a pin;
a threaded rod; said threaded rod being screw threaded along its entire length to provide attachment means to said threaded hole of said rod; said threaded rod having a flat on one distal end with a slotted cut along the centerline to provide a means of attachment to said threaded hole of said rod using a flat bladed screwdriver tool;
a pin; said pin having a transverse threaded thru hole at its center to provide a means of attachment to said threaded rod; said pin being concentrically mated to said thru hole of said handle; and
a cam locking washer; said washer having a notch cut at one distal end to provide a means of concentrically engagement with said cylindrical shape of said handle;
said washer having a thru hole at its center to provide clearance for concentric alignment with said threaded rod; said washer having a metallic portion at its opposite end to provide a means of providing a frictional and releasable lock between said rod mounting bracket and said handle.
a pair of security rings; said ring comprising a first circular ring portion of a strong metal such as steel and a second post section having a closed loop at one end to provide non removable attachment to said first portion; said first security ring being rigidly attached to said blind hole of said third tube; said second security ring being rigidly attached to said bottom frame assembly of the passenger's seat; and
a steel wire cable; said steel wire cable being of sufficient thickness to prevent cutting by tools such as scissors or knives; said cable being rigidly attached to said first security ring of at one distal end and being rigidly attached to said second security ring at the opposite distal end.

1. A second apparatus for assisting obese airplane passengers to sleep during air travel, comprising:
a first hollow tube; said tube having two slotted apertures located symmetrically about its center point; said first tube to provide means for resting on said passenger's lap during sleeping;
a pair of second hollow tubes; said second tubes having a closed face at one distal end and a hollow opening at the opposite distal end to provide means of slidable engagement with said first tube; said second tubes having a blind threaded hole near the open distal end to provide means for attachment of a screw to provide a means to limit the travel of said second tubes in slidable engagement with said first tube;
a third hollow tube; said third tube having a blind hole to provide a means of rigid attachment to a metal security ring; said third tube having a transverse thru hole near its bottom distal end to provide a means for attachment of said first tube;
a first end cap, said first end cap having a threaded thru hole at its center to provide a means for locking the position of said first tube using a set screw;
a pair of second end caps, said second end cap having a closed outside face and a smaller diameter end to provide a means for rigid attachment to the far distal end of said second hollow tubes;
a first bar; said first bar having a hollow cylindrical portion at its bottom distal end to provide a means for slidable engagement to said third hollow tube; said first bar having a T shaped protrusion extending from its top distal end to provide a means for attachment to a second bar; said first bar having a rectangular transverse aperture located near to top distal end to provide clearance for said second bar; said first bar having a first threaded blind hole located approximately 1 inch from the top surface of said first bar to provide a means for attachment to a thumb locking screw; said first bar having a second threaded blind hole tapped in from the opposite end to said first threaded hole; said second tapped hole being located approximately 2 inches from said top end of said first bar and providing a means of attachment to a locking device; said first bar having a blind hole located approximately 1.25 inches from said top end of said first bar to provide a means for rid attachment of a pin;
a second bar; said second bar having a first circular flange portion and a second square bar portion extending outward from said first flange portion; said first flange portion having a plurality of screw clearance holes to provide a means of rigid attachment to a cushion support plate; said second square protrusion having a slotted aperture along the centerline of said second bar to provide a means of slidable engagement with said pin located in said first bar;
a thumb locking screw; said thumb screw having a first knurled cylindrical head portion for providing a means of applying sufficient locking torque from hand pressure and a second threaded portion extending outward from said first cylindrical head portion; said thumb screw to provide a means of locking the angular position between the axis of said first and said second bars;
a bar pin; said bar pin being rigidly attached to said blind hole of said first bar;
a locking device; said locking device comprising:
a hollow shaped housing with an internal diameter sized to press fit into said upper distal opening of said third tube; said housing having a thru hole running longitudinally to provide means for attachment to a pin; said housing having a notch shaped protrusion near its upper distal opening to provide a means for slidable engagement with said notch cut of said fourth tube;
a pin; said pin rigidly attached to said thru hole in said housing;
a thumb locking tab; said tab concentrically and movably attached to said pin;
said tab having a curved shape that provides a means for creating a frictional lock between said third and said fourth tubes;
a cushion; said cushion being U-shaped to provide a means for the passenger's head to press against said cushion where the nose and mouth of said passenger are inside the U opening to allow for breathing; said cushion having a plurality of Velcro strips attached to bottom face of said cushion to provide a means of attachment to a cushion support plate;
a cushion support plate; said plate being U-shaped; said plate having a plurality of Velcro strips to mate with said Velcro strips attached to said cushion provide means for detachment of said cushion to said plate; said plate having a plurality of tapped holes adjacent to its outer perimeter along the horizontal centerline to provide attachment means to a pair of rod mounting brackets; said support plate having a plurality of tapped holes at the rear face to provide a means of attachment to said circulate flange of said second bar;
a pair of rod mounting brackets; said brackets having a diamond shape with a single rectangular protrusion located at one side to provide a means of rigid attachment to said tapped holes of said cushion support plate; said brackets having a single thru hole located near the bottom apex to provide means of attachment to a belt mounting bracket;
a belt mounting bracket; said mounting bracket being of triangular shape and having a blind hole at one corner of said bracket to provide a means for attachment to said rod mounting bracket; said belt mounting bracket having a slotted aperture adjacent and parallel to the bottom edge of said mounting bracket;
a belt comprising:
a pair of first belt sections being made of a strong polymeric fiber such as nylon;
said first belt section having a length between six and nine inches; said belt first section having closed loops at both distal ends; said first closed loop to provide a means of attachment to said slotted apertures of said belt mounting bracket; said second closed loop to provide a means of attachment to a belt buckle;
a pair of first belt buckles; said buckles having a slotted aperture at one distal end to provide a means for attachment to said second closed loops of said first belt sections; said buckles having a rectangular aperture at the opposite distal end to provide a means for attachment to a pair of second belt buckles;
a pair of second belt buckles; said second buckles having a pair of slotted apertures at one distal end to provide a means for attachment to a pair of second belt sections; said second buckles having a pair of flexible locking tabs at the opposite distal end to provide a means of releasable attachment to said rectangular apertures of said first belt buckles; and a
a second belt section; said second belt section being made of a strong polymeric fiber such as nylon; said second belt section having a length between 55 and 60 inches; said second belt section having thicker ends to provide a means for preventing detachment from said second belt buckles; said second belt section being looped thru said pairs of slotted apertures of said second buckles to provide a means of length adjustment of said belt;
a pair of belt securing brackets; said belt securing brackets being rigidly attached to the backside of the passenger's seat at approximately 6 to 8 inches from the top face of said seat and adjacent to the seat perimeter; said brackets each having two L shaped protrusions along the top and bottom edges to provide a means for retaining said belt;
a bar locking device; said bar locking device comprising:
a handle; said handle having a curved shape at one distal end and a cylindrical shape at the far distal end; said cylindrical shape having a thru hole at its center to provide a means for rigid attachment to a pin;
a threaded rod; said threaded rod being screw threaded along its entire length to provide attachment means to said threaded hole of said first bar; said threaded rod having a flat on one distal end with a slotted cut along the centerline to provide a means of attachment to said threaded hole of said rod using a flat bladed screwdriver tool;
a pin; said pin having a transverse threaded thru hole at its center to provide a means of attachment to said threaded rod; said pin being concentrically mated to said thru hole of said handle; and
a cam locking washer; said washer having a notch cut at one distal end to provide a means of concentrically engagement with said cylindrical shape of said handle;
said washer having a thru hole at its center to provide clearance for concentric alignment with said threaded rod; said washer having a metallic portion at its opposite end to provide a means of providing a frictional and releasable lock between said first bar and said second bar.
a pair of security rings; said ring comprising a first circular ring portion of a strong metal such as steel and a second post section having a closed loop at one end to provide non removable attachment to said first portion; said first security ring being rigidly attached to said blind hole of said third tube; said second security ring being rigidly attached to said bottom frame assembly of the passenger's seat; and
a steel wire cable; said steel wire cable being of sufficient thickness to prevent cutting by tools such as scissors or knives; said cable being rigidly attached to said first security ring of at one distal end and being rigidly attached to said second security ring at the opposite distal end.
